(19) United States
(12) Patent Application Publication
(10) Pub. No.: US 2022/0033714 A1
(43) Pub. Date: Feb. 3, 2022

(54) METHODS AND APPARATUSES FOR PROCESSING HYDROCARBONS TO PRODUCE LIGHT OLEFINS

(71) Applicant: Saudi Arabian Oil Company, Dhahran (SA)

(72) Inventors: Khalid A. Al-Majnouni, Jeddah (SA); Mohammed Abdulmajeed Al-Daous, Thuwal (SA); Abdulrahman Faroug Almasri, Thuwal (SA); Ahmad Alrefaei, Jeddah (SA); Ola S. Ali, Thuwal (SA); Isidoro Morales Osorio, Thuwal (SA)

(21) Appl. No.: 16/940,668

(22) Filed: Jul. 28, 2020

(51) Int. Cl. C10G 11/18; B01J 8/28

(52) U.S. Cl. CPC C10G 11/182; B01J 8/28; C10G 2400/20; B01J 2208/00557; C10G 2300/701; C10G 2300/4025; C10G 2300/4093; C10G 2300/4018

(57) ABSTRACT

Light olefins may be produced from hydrocarbons by a method including passing a hydrocarbon feed stream into a feed inlet of a reactor. The reactor may include an upper reactor portion defining an upper reaction zone and a lower reactor portion defining a lower reaction zone. The catalyst may move in a generally downward direction through the upper reactor portion and the lower reactor portion, and the hydrocarbon feed stream may move in a generally upward direction through the upper reactor portion and lower reactor portion such that the hydrocarbon feed stream and the catalyst move with a counter-current orientation. Contacting the catalyst with the hydrocarbon feed stream may crack one or more components of the hydrocarbon feed stream and form a hydrocarbon product stream. The method may further include passing the hydrocarbon product stream out of the upper reaction zone through the hydrocarbon product outlet.

### TECHNICAL FIELD

Embodiments of the present disclosure generally relate to methods for processing hydrocarbons, and more specifically, to methods for processing hydrocarbons to produce olefins.

### BACKGROUND

Light olefins, including ethylene, propylene, and butene, are basic intermediates used by a large portion of the petrochemical industry. In particular, pure streams of light olefins may be used during the production of various polymers and chemicals. Traditionally, light olefins may be produced by thermal cracking of petroleum fractions such as naphtha, kerosene, or gas oil. Light olefins could also be produced by catalytic cracking processes. As the demand for light olefins increases, there is a need for improved methods to produce light olefins.

### SUMMARY

Conventional catalytic cracking processes operate with a relatively small amount of catalyst in the reactor by utilizing lean bed or circulating fluidization regimes, such as dilute fluidized beds. Additionally, conventional catalytic cracking processes may utilize co-current flow patterns whereby the catalyst and hydrocarbons flow through the reactor in the same direction, which can result in undesirable flow patterns such as back-mixing and core-annular flow. Embodiments of the present disclosure are directed to methods to produce light olefins by catalytic cracking, where the catalyst and hydrocarbons contact each other in a counter-current manner and where a portion of the reactor operates with a dense bed fluidization regime. Dense bed fluidization may allow more catalyst to be present in the reactor, which in turn may lead to higher conversion of the hydrocarbon and higher yield of light olefins than observed in traditional catalytic cracking processes. Counter-current flow may be describable to increase the conversion of the feed. For example, during counter-current flow, fresh catalyst may move from the top of the reactor to the bottom of the reactor while hydrocarbon feed flows from the bottom to the top of the reactor. The spent catalyst at the bottom of the reactor and nearing the exit of the reactor contacts with the feed flowing upward and converts the reactive components in the feed. The less reactive components in the feed are converted as the feed travels upward, contacting the hot and fresh catalyst in the top section of the reactor. Additionally, counter-current contact between the hydrocarbons and catalyst may prevent back-mixing or core-annular flow, which are often leads to a reduced yield of light olefins in traditional riser reactors where the catalyst and hydrocarbons flow through the reactor co-currently.

According to one or more embodiments, light olefins may be produced from hydrocarbons by a method comprising passing a hydrocarbon feed stream into a feed inlet of a reactor. The reactor may comprise an upper reactor portion defining an upper reaction zone and a lower reactor portion defining a lower reaction zone. The upper reactor portion may comprise a catalyst inlet and a hydrocarbon product outlet where the catalyst inlet and the hydrocarbon product outlet are positioned at or near the top of the upper reactor portion. The lower reactor portion may comprise a feed inlet and a catalyst outlet, where the feed inlet and the catalyst outlet are positioned at or near the bottom of the lower reactor portion. The lower reaction zone may be in fluid communication with and adjacent to the upper reaction zone. The catalyst may move in a generally downward direction through the upper reactor portion and the lower reactor portion, and the hydrocarbon feed stream may move in a generally upward direction through the upper reactor portion and lower reactor portion such that the hydrocarbon feed stream and the catalyst move with a counter-current orientation. The upper reaction zone may operate with a counter-current plug flow regime, and the lower reaction zone may operates with a dense bed fluidization regime. Contacting the catalyst with the hydrocarbon feed stream may crack one or more components of the hydrocarbon feed stream and form a hydrocarbon product stream. The hydrocarbon product stream may comprise one or more of ethylene, propylene, or butene. The method may further comprise passing the hydrocarbon product stream out of the upper reaction zone through the hydrocarbon product outlet

According to one or more embodiments, light olefins may be produced from hydrocarbons by a method comprising passing a hydrocarbon feed stream into a feed inlet of a reactor. The reactor may comprise an upper reactor portion defining an upper reaction zone and a lower reactor portion defining a lower reaction zone. The upper reactor portion may comprise a catalyst inlet and a hydrocarbon product outlet. The catalyst inlet and the hydrocarbon product outlet may be positioned at or near the top of the upper reactor portion. The lower reactor portion may comprise a feed inlet and a catalyst outlet. The feed inlet and the catalyst outlet may be positioned at or near the bottom of the lower reactor portion. The lower reaction zone may be in fluid communication with and adjacent to the upper reaction zone. The catalyst may have a downward superficial velocity through the upper reactor portion and the lower reactor portion and the hydrocarbon feed stream may have an upward superficial velocity through the upper reactor portion and lower reactor portion such that the hydrocarbon feed stream and the catalyst move with a counter-current orientation. The upper reaction zone may operate with a counter-current plug flow regime, where the catalyst-to-oil ratio in the upper reaction zone is from 5 to 100 and the superficial velocity of the hydrocarbon feed stream in the upper reaction zone is 3.0 m/s or less. The lower reaction zone may operate with a dense bed fluidization regime, where a weight hourly space velocity of the lower reaction zone is from 1 to 200 hr-1. Contacting the catalyst with the hydrocarbon feed stream may crack one or more components of the hydrocarbon feed stream and form a hydrocarbon product stream. The hydrocarbon product stream may comprise one or more of ethylene, propylene, or butene. The method may further comprise passing the hydrocarbon product stream out of the upper reaction zone through the hydrocarbon product outlet.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor and catalyst regenerator for producing light olefins, according to one or more embodiments disclosed herein; and

FIG. 2 schematically depicts a cross-sectional view of the upper reactor portion of a reactor for producing light olefins, according to one or more embodiments disclosed herein.

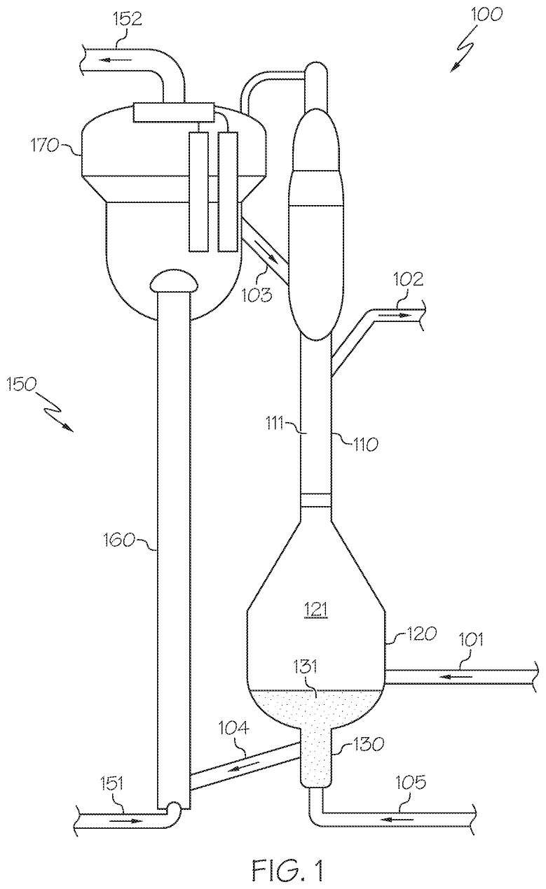

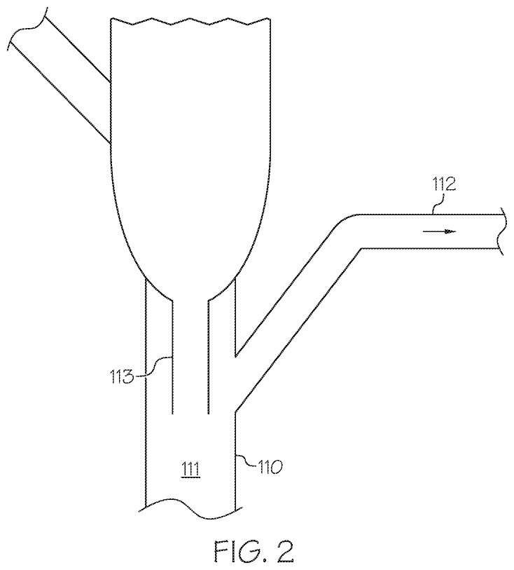

For the purpose of describing the simplified schematic illustrations and descriptions of FIGS. 1 and 2, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in cracking units, such as bleed streams, spent catalyst discharge subsystems, and catalyst replacement sub-systems are also not shown. It should be understood that these components are within the spirit and scope of the present embodiments disclosed. It should be understood that the reactor diameter should not be inferred from the drawings and that the diameter of the reactor may be similar or different to the depiction in the drawings. Additionally, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to systems and processes for processing hydrocarbons to produce light olefins. Various embodiments are discussed herein. However, it should be understood that the forgoing detailed description section describes one or more specific embodiments and should not be viewed as limiting the scope of the appended claims.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors. One or more “reaction zones” may be disposed in a reactor. As used in this disclosure, a “reaction zone” refers to an area where a particular reaction takes place in a reactor.

As used in this disclosure, a “catalyst” refers to any substance which increases the rate of a specific chemical reaction. Catalysts described in this disclosure may be utilized to promote various reactions, such as, but not limited to, cracking. As used in this disclosure, “cracking” generally refers to a chemical reaction where a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

As used in this disclosure, the term “spent catalyst” refers to catalyst that has been introduced to and passed through a reaction zone to crack a hydrocarbon feed, but has not been regenerated in the regenerator following introduction to the reaction zone. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration.

As used in this disclosure, the term “regenerated catalyst” refers to catalyst that has been introduced to a reaction zone and then regenerated in a regenerator to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both compared to spent catalyst and may have greater catalytic activity compared to spent catalyst. The “regenerated catalyst” may have more coke and lesser catalytic activity compared to fresh catalyst that has not passed through a cracking reaction zone and regenerator.

Referring now to FIG. 1, a reactor 100 for producing light olefins is schematically depicted. The reactor comprises an upper reactor portion 110, a lower reactor portion 120, and a steam stripping portion 130. The upper reactor portion 110 may comprise an upper reaction zone 111. The lower reactor portion 120 may define a lower reaction zone 121. A hydrocarbon feed stream 101 may enter the lower reaction zone 121 through one or more feed inlets located in the lower reactor portion 120. The one or more feed inlets may be positioned at or near the bottom of the lower reactor portion 120. Additionally, the lower reactor portion 120 may comprise one or more catalyst outlets positioned at or near the bottom of the lower reactor portion 120. As described herein, at or near the bottom of the lower reactor portion 120 corresponds to positions in the bottom 10%, bottom 5%, or even bottom 1% of the height of the lower reactor portion 120.

The upper reactor portion 110 defines an upper reaction zone 111. The hydrocarbon feed stream 101 may move through the lower reaction zone 121 and into the upper reaction zone 111. The upper reactor portion 110 and the lower reactor portion 120 may be in fluid communication with each other. In one or more embodiments, the upper reactor portion 110 and the lower reactor portion may be adjacent to each other, with no intervening components or reactor portions. In one or more embodiments, the hydrocarbon feed stream 101 may pass directly from the lower reactor portion 120 to the upper reactor portion 110.

Referring to FIG. 2, a cross-sectional view of the upper reactor portion 110 is shown. The upper reactor portion 110 includes a hydrocarbon product outlet 112 and a catalyst inlet 113, which may be positioned at or near the top of the upper reactor portion 110. As described herein, at or near the top of the upper reactor portion 110 corresponds to positions in the top 10%, top 5%, or even top 1% of the height of the upper reactor portion 110. Catalyst may enter the upper reactor portion 110 through catalyst inlet 113. As shown in FIG. 2, the catalyst inlet 113 may extend into the upper reactor portion 110 so the catalyst enters the upper reaction zone 111 below the hydrocarbon product outlet 112. As shown in FIG. 2, the hydrocarbon product outlet 112 is defined by an opening in the upper reactor portion 110, and the hydrocarbon product outlet 112 does not extend into upper reaction zone 111. Thus, catalyst may enter the upper reaction zone below the hydrocarbon outlet 112. Without wishing to be bound by theory, it is believed that introducing the catalyst below the hydrocarbon product outlet 112 may reduce the amount of catalyst entrained in the hydrocarbon product exiting the reactor 100.

In one or more embodiments, the hydrocarbon feed stream 101 may comprise, consist of, or consist essentially of crude oil. As described herein, “crude oil” refers to a naturally occurring mixture of petroleum liquids and gasses. Generally, crude oil may undergo minimal processing before use in the methods described herein. Crude oils contemplated herein include those having an API gravity of from 25° to 40°, such as from 25° to 30°, from 30° to 35°, from 35° to 40°, or any combination of these ranges. In further embodiments, the hydrocarbon feed stream 101 may comprise a fraction of crude oil, or a petrochemical product formed from a crude oil, having an initial boiling point of at least 25° C. For example, in one or more embodiments, the hydrocarbon feed stream may comprise light naphtha and may have an initial boiling point from 25° C. to 35° C. and a final boiling point of from 85° C. to 95° C. In one or more embodiments, the hydrocarbon feed may comprise heavy naphtha and may have an initial boiling point from 80° C. to 95° C. and a final boiling point from 190° C. to 210° C. In further embodiments, the hydrocarbon feed stream may comprise full range naphtha and have an initial boiling point from 25° C. to 35° C. and a final boiling point from 190° C. to 210° C.

In one or more embodiments, the hydrocarbon feed stream may comprise one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

In one or more embodiments, the catalyst may comprise a zeolite catalyst, for example, USY zeolite, ZSM-5 zeolite, or a combination of multiple types of suitable zeolite catalysts. Alternatively, the catalyst may comprise other suitable solid acid catalysts. In one or more embodiments, the catalyst may comprise fresh catalyst, regenerated catalyst, or combinations of fresh and regenerated catalyst as described in further detail herein. In one or more embodiments, the catalyst may comprise binders, promotors, inert, and matrix to have acceptable physical and chemical properties such as catalyst attrition index and catalyst density so that it can be used in the proposed reactor configuration.

As shown in FIG. 1, the lower reactor portion 120 may have a larger cross-sectional area than the upper reactor portion 110. In one or more embodiments, the lower reactor portion 120 may have a substantially similar cross-sectional area to the upper reactor portion 110.

In one or more embodiments, the upper reaction zone 111 may operate in a counter-current plug flow regime. In one or more embodiments, the hydrocarbon feed 101 may exhibit plug flow as it moves up through the upper reaction zone 111. Likewise, the catalyst may exhibit plug flow as it moves down through the upper reaction zone 111. Since the flow of catalyst is opposed to the flow of the hydrocarbon feed, the flows are counter-current and the upper reaction zone 111 may operate in a counter-current plug flow regime.

In one or more embodiments, the catalyst-to-oil ratio in the upper reaction zone 111 may be from 5 to 100. For example, the catalyst-to-oil ratio in the upper reaction zone 111 may be from 5 to 100, from 10 to 100, from 20 to 100, from 30 to 100, from 40 to 100, from 50 to 100, from 60 to 100, from 70 to 100, from 80 to 100, or even from 90 to 100. In further examples, the catalyst-to-oil ratio in the upper reaction zone 111 may be from 5 to 90, from 5 to 80, from 5 to 70, from 5 to 60, from 5 to 50, from 5 to 40, from 5 to 30, from 5 to 20, or even from 5 to 10. Without wishing to be bound by theory, it is believed that there is less constraint on catalyst-to-oil ratios suitable for use in the upper reaction zone 111 because the catalyst may flow through the upper reaction zone 111 by gravity instead of being transported through the reactor by the flow of hydrocarbons. Additionally, a high catalyst-to-oil ratio indicates a large amount of catalyst within the upper reaction zone 111, which is believed to lead to increased conversion of the hydrocarbon feed to light olefins.

The catalyst may move through the upper reaction zone 111 and into the lower reaction zone 121. In one or more embodiments, the catalyst may pass directly from the upper reaction zone 111 to the lower reaction zone 121. The lower reaction zone 121 may operate in a dense bed fluidization regime. In one or more embodiments, the catalyst may pass from the upper reaction zone 111 to the lower reaction zone 121 and form a dense fluidized bed in the lower reaction zone 121. As described herein, a “dense bed fluidization regime” refers to a fluidization regimes in which the fluidized bed has a clearly defined upper limit or surface to the dense bed. For example, dense bed fluidization regimes include the smooth fluidization, bubbling fluidization, slugging fluidization, and turbulent fluidization regimes. In a dense fluidized bed, the particle entrainment rate may be low, but may increase as the velocity of the gas flowing through the bed increases.

In one or more embodiments, the weight hourly space velocity (WHSV) of the lower reaction zone 121 may be from 1 to 200 hr⁻¹. For example, the WHSV of the lower reaction zone 121 may be from 1 to 200 hr⁻¹, from 1 to 175 hr⁻¹, from 1 to 150 hr⁻¹, from 1 to 125 hr⁻¹, from 1 to 100 hr⁻¹, from 1 to 75 hr⁻¹, from 1 to 50 hr⁻¹, or even from 1 to 25 hr⁻¹. In further examples, the WHSV of the lower reaction zone 121 may be from 25 to 200 hr⁻¹, from 50 to 200 hr⁻¹, from 75 to 200 hr⁻¹, from 100 to 200 hr⁻¹, from 125 to 200 hr⁻¹, from 150 to 200 hr⁻¹, or even from 175 to 200 hr⁻¹. WHSV may be used to describe the amount of catalyst in the dense bed of the lower reaction zone 121. Without wishing to be bound by theory, it is believed that a dense bed allows a large amount of catalyst to be present in the lower reaction zone, which may increase the yield of light olefins.

As the hydrocarbon feed stream 101 and the catalyst move through the reactor 100, the hydrocarbon feed stream 101 may have an upward superficial velocity through a horizontal cross-section of the reactor 100, and the catalyst may have a downward superficial velocity through a horizontal cross-section of the reactor 100. As described herein, “superficial velocity” refers to the velocity at which an individual phase flows through a given cross-sectional area. The bulk flow of a phase is used to determine superficial velocity of that phase; thus, individual particles or molecules within a phase may move in a direction different from, or even opposite to, the bulk flow of a phase without affecting the direction of the superficial velocity of that phase.

For example, the hydrocarbon feed stream 101 flows from the feed inlet in the lower reactor portion 120 to the hydrocarbon product outlet 112 in the upper reactor portion 110. Thus, the bulk flow of hydrocarbon feed stream 101 moving through a horizontal cross-section of the reactor 100 is in an upward direction, resulting in an upward superficial velocity. Likewise, the catalyst flows from the catalyst inlet 113 to the catalyst outlet in the steam stripping portion 130 of the reactor 100, and the bulk flow of the catalyst moving through a horizontal cross-section of the reactor 100 is in a downward direction, resulting in a downward superficial velocity. In one or more embodiments, the upward superficial velocity of the hydrocarbon feed stream 101 and the downward superficial velocity of the catalyst results in a counter-current flow pattern between the hydrocarbon feed stream 101 and the catalyst. Thus, in one or more embodiments, the hydrocarbon feed stream 101 and catalyst move with a counter-current orientation.

Without wishing to be bound by theory, it is believed that contacting the hydrocarbon feed stream 101 and the catalyst in a counter-current manner may prevent back-mixing of catalyst that may occur in in traditional riser reactors and may promote undesired side reactions that negatively affect the production of light olefins. Additionally, it is believed that contacting the hydrocarbon feed stream 101 and the catalyst in a counter-current manner may prevent core-annular flow through the reactor where the catalyst has high concentration near the reactor walls and a low concentration toward the center of the reactor where a majority of the hydrocarbon flow occurs. Generally, core-annular flow reduces the amount of contact between the catalyst and the hydrocarbon, and thus, may reduce the conversion of hydrocarbon feed to light olefins.

Without wishing to be bound by theory, it is also believed that counter-current flow may also result in increased yield of olefins by allowing the more reactive chemicals in the hydrocarbon feed to contact less active catalyst, and less active catalyst to contact more reactive chemicals in the hydrocarbon feed. Generally, the catalyst in the lower reaction zone 121 has already contacted hydrocarbons in the upper reaction zone 111. Thus, the catalyst in the lower reaction zone 121 is usually partially spent and has a lower activity than the catalyst in the upper reaction zone 111. Contacting the hydrocarbon feed with a large amount of less active catalyst in the lower reaction zone 121 may allow the more reactive chemicals in the hydrocarbon feed to crack in the lower reaction zone 121 while contacting the less active catalyst. This in turn allows the more active catalyst in the upper reaction zone 111 to crack the less reactive chemicals in the hydrocarbon feed, increasing the yield of light olefins produced from the hydrocarbon feed.

In one or more embodiments, the superficial velocity of the hydrocarbon feed stream 101 moving through the upper reactor portion 111 is 3.0 m/s or less. For example, the superficial velocity of the hydrocarbon feed stream through the upper reactor portion 111 may be 3.0 m/s or less, 2.0 m/s or less, 1.0 m/s or less, 0.9 m/s or less, 0.8 m/s or less, 0.7 m/s or less, 0.6 m/s or less, 0.5 m/s or less, or even 0.4 m/s or less. Without wishing to be bound by theory, it is believed that a hydrocarbon feed stream superficial velocity below 3.0 m/s within the upper reactor portion 111 may result in increased contact between the catalyst and the hydrocarbons, which may in turn lead to increased conversion of the hydrocarbon feed to light olefins. To keep the superficial velocity of the hydrocarbon feed stream 101 within the desired range, the residence time of the hydrocarbons within the reactor 100 may be controlled by adjusting the height of the upper reactor portion 110 and the height of the lower reactor portion 120.

In one or more embodiments, the residence time of the hydrocarbon feed stream 101 within the reactor 100 is from 0.1 to 10 seconds. For example, the residence time of the hydrocarbon feed stream 101 within reactor 100 may be from 0.1 to 10 seconds, from 0.5 to 10 seconds, from 1 to 10 seconds, from 2 to 10 seconds, from 3 to 10 seconds, from 4 to 10 seconds, from 5 to 10 seconds, from 6 to 10 seconds, from 7 to 10 seconds, from 8 to 10 seconds, or even from 9 to 10 seconds. In further examples, the residence time of the hydrocarbon feed stream 101 in the reactor 100 may be from 0.1 to 9 seconds, from 0.1 to 8 seconds, from 0.1 to 7 seconds, from 0.1 to 6 seconds, from 0.1 to 5 seconds, from 0.1 to 4 seconds, from 0.1 to 3 seconds, from 0.1 to 2 seconds, or even from 0.1 to 1 second.

As the hydrocarbon feed stream 101 contacts the catalyst, at least a portion of the hydrocarbon feed stream 101 may be cracked to form a hydrocarbon product. In one or more embodiments, the temperature within the reactor 100 may be from 420° C. to 750° C. to facilitate the cracking of hydrocarbon feed stream 101. For example, the temperature within the reactor 100 may be from 460° C. to 750° C., from 500° C. to 750° C., from 540° C. to 750° C., from 580° C. to 750° C., from 620° C. to 750° C., from 660° C. to 750° C., or even from 700° C. to 750° C. In further examples, the temperature within the reactor 100 may be from 420° C. to 710° C., from 420° C. to 670° C., from 420° C. to 630° C., from 420° C. to 590° C., from 420° C. to 550° C., or even from 420° C. to 510° C. In yet further embodiments, the temperature within the reactor 100 may be from 440° C. to 720° C., from 480° C. to 680° C.

In one or more embodiments, the hydrocarbon product may comprise light olefins and other reactions products. For example the hydrocarbon product may comprise, ethylene, propylene, butene or combinations of these in addition to the other reactions products. In one or more embodiments, the other reaction products may comprise dry gas, aromatics, naphtha, light cycle oil, heavy cycle oil, and even heavy oil. In one or more embodiments, a hydrocarbon product stream 102 comprising light olefins may be passed from the upper reaction zone 111 through hydrocarbon product outlet 112 in the upper reactor portion 110. In one or more embodiments, the hydrocarbon product stream 102 may comprise catalyst entrained within the hydrocarbon product stream 102 which may be separated from the hydrocarbon product stream 102 in a separation device. Any suitable separation device, including a cyclone or series of cyclones, may be used to separate entrained catalyst from the hydrocarbon product stream 102. In one or more embodiments, the light olefins may be separated from the hydrocarbon product stream 102. Separation of the light olefins from the hydrocarbon product stream may be achieved by any suitable means including, for example, distillation. In one or more embodiments, the separation of light olefins from the hydrocarbon product stream may result in relatively pure streams of ethylene, propylene, or butene.

In one or more embodiments, cracking the hydrocarbon feed stream 101 may produce spent catalyst. Spent catalyst may be produced in both the upper reaction zone 111 and the lower reaction zone 121. In one or more embodiments, spent catalyst may comprise coke on the catalyst. The coke may reduce the activity of the catalyst, and spent catalyst may have reduced activity when compared to regenerated or fresh catalyst. In one or more embodiments, the non-circulating fluidized bed of the lower reaction zone 121 may comprise spent catalyst. Without wishing to be bound by theory, the more reactive components of the hydrocarbon feed stream may crack in the lower reaction zone because high catalytic activity is not required for those components to react. As the hydrocarbon feed passes from the lower reaction zone 121 to the upper reaction zone 111, the hydrocarbon feed will encounter more active, fresh or regenerated catalyst, and the less reactive components of the hydrocarbon feed will crack. Thus, the counter-current flow of the catalyst and the hydrocarbon feed stream 101 may result in increased conversion of hydrocarbon feed to light olefins.

In one or more embodiments, the reactor 100 may comprise a steam stripping portion 130 below the lower reactor portion 120. The steam stripping portion 130 may define a steam stripping zone 131. The steam stripping portion 130 may be in fluid communication with and adjacent to the lower reactor portion 120. In one or more embodiments, spent catalyst may pass from the lower reaction zone 121 to the steam stripping zone 131. In further embodiments, the spent catalyst may pass directly from the lower reaction zone 121 to the steam stripping zone 131. Steam may be passed to the steam stripping zone 131 by stream 105. In the steam stripping zone 131, steam may contact the spent catalyst and strip at least a portion of the hydrocarbon feed or hydrocarbon products from the spent catalyst. After contacting the steam in the steam stripping zone 131, spent catalyst may be passed in stream 104 from the reactor 100 through the catalyst outlet.

In one or more embodiments, the spent catalyst may be passed to a catalyst regenerator 150 where the spent catalyst is regenerated to form a regenerated catalyst. The catalyst regenerator 150 may comprise a riser 160 and a separator 170. The spent catalyst may enter the riser 160 through a catalyst inlet. In one or more embodiments, the riser 160 is in fluid communication with the steam stripping zone 131 of the reactor 100 and the spent catalyst may be passed directly from the steam stripping zone 131 to the riser 160. In one or more embodiments, an air stream 151 is passed to the riser 160, and the air and spent catalyst travel up riser 160. In one or more embodiments, the air stream 151 is used to oxidize at least a portion of the coke on the spent catalyst, restoring activity to the spent catalyst and forming a regenerated catalyst.

The regenerated catalyst and air may move from riser 160 to separator 170. In one or more embodiments, the riser 160 and separator 170 are adjacent to each other and the regenerated catalyst and air move directly from the riser 160 to the separator 170. Separator 170 may be any suitable separation system for separating catalyst from air, including a cyclone separation system. In one or more embodiments, an air stream 152 may exit the separator 170. Additionally, regenerated catalyst may exit the separator 170 through a regenerated catalyst outlet. In one or more embodiments, the regenerated catalyst may be included in the catalyst of stream 103. In one or more embodiments, the separator 170 and the upper reactor portion 110 may be in fluid communication with each other and regenerated catalyst may be passed directly from the separator 170 of the regenerator 150 to the upper reaction zone 111 of the reactor 100 through catalyst inlet 113. In one or more embodiments, fresh catalyst may be added to catalyst in stream 103. In such embodiments, the catalyst may comprise both regenerated catalyst and fresh catalyst.

### Examples

The following examples illustrate one or more additional features of the present disclosure. In the following examples, a hydrocarbon feed stream was cracked to light olefins in the presence of catalyst samples that contained mixtures of spent catalyst and fresh catalyst to simulate a reactor having a lower fluidized bed and an upper counter-current plug flow reaction zone as described in this disclosure.

A micro-activity testing (MAT) unit was used to determine the conversion and selectivity of a hydrocarbon stream at different catalyst-to-oil ratios to simulate changing the amount of catalyst (catalyst hold-up) in the counter-current reactor. The hydrocarbon stream was hexane, and cracking occurred at 650° C. The catalyst was a ZSM-5 based solid acid catalyst. Catalyst-to-oil ratios of 4.69, 7.06, and 10.61 were examined and the light olefin yields are displayed in Table 1.

TABLE 1

| | CAT/OIL | | |
|---|---|---|---|
| | 4.96 | 7.06 | 10.61 |
| Yields | Wt. % | | |
| H₂ | 0.226 | 0.293 | 0.358 |
| C₁ | 2.34 | 2.88 | 3.23 |
| C₂ | 4.94 | 6.28 | 7.40 |
| C₂= | 7.51 | 10.12 | 12.26 |
| C₃ | 6.04 | 8.37 | 10.54 |
| C₃= | 16.32 | 19.93 | 22.25 |
| iC₄ | 0.23 | 0.38 | 0.53 |
| nC₄ | 1.59 | 2.16 | 2.63 |
| t2C₄= | 1.69 | 2.09 | 2.26 |
| 1C₄= | 1.57 | 1.82 | 2.02 |
| iC₄= | 2.59 | 3.14 | 3.45 |
| _{c}2C₄= | 1.39 | 1.70 | 1.87 |
| 1,3-BD | 0.031 | 0.047 | 0.074 |
| C₄= (liquid) | 0.00 | 0.00 | 0.00 |
| Total Gas | 46.47 | 59.20 | 68.88 |
| Gasoline | 53.30 | 40.70 | 30.96 |
| LCO | 0.00 | 0.00 | 0.00 |
| HCO | 0.00 | 0.00 | 0.00 |
| Coke | 0.231 | 0.101 | 0.164 |

As displayed in Table 1, the yield of light olefins increased as the catalyst-to-oil ratio increased. Additionally, the yield of coke decreased as the catalyst-to-oil ratio increased. This was likely due to a reduction in the bimolecular reactions that lead to coke formation. Since an increase in catalyst-to-oil ratio correlates to an increased amount of catalyst within the reactor, increasing the catalyst hold-up in the reactor leads to increased hydrocarbon conversion to light olefins. Additionally, the conversion hydrocarbons to light olefins can be achieved in reactors of reduced size when the amount of catalyst in the reactor is increased.

The conversion of hydrocarbons to light olefins using two layers of catalyst was performed in a MAT unit. The hydrocarbon stream was hexane, and cracking occurred at 650° C. The first catalyst layer was partially deactivated catalyst. The catalyst was deactivated at 810° C. for six hours under 100% steam. The first catalyst layer made up 30% of the total catalyst in the MAT unit. The first catalyst layer represents the dense fluidized bed portion of the reactor described in the disclosure. The second catalyst layer was fresh catalyst and made up 70% of the catalyst in the MAT unit. The second catalyst layer represents the counter-current plug flow section of the reactor described in the disclosure. The yield of light olefins from hexane cracked by the double layer catalyst is displayed in Table 2. Table 2 also displays the yield of light olefins from the single layer catalyst with a catalyst-to-oil ratio of 10.61 of Example 1.

TABLE 2

Catalyst Layers

| | |
|---|---|
| 1 | 2 |

Catalyst-to-Oil Ratio

| | |
|---|---|
| 10.61 | 9.60 |

| | |
|---|---|
| Yields | Wt. % |

| | | |
|---|---|---|
| H₂ | 0.358 | 0.337 |
| C₁ | 3.23 | 2.87 |
| C₂ | 7.40 | 7.02 |
| C₂= | 12.26 | 11.25 |
| C₃ | 10.54 | 10.15 |
| C₃= | 22.25 | 21.27 |
| iC₄ | 0.53 | 0.49 |
| nC₄ | 2.63 | 2.55 |
| t2C₄= | 2.26 | 2.18 |
| 1C₄= | 2.02 | 1.96 |
| iC₄= | 3.45 | 3.33 |
| _{c}2C₄= | 1.87 | 1.80 |
| 1,3-BD | 0.074 | 0.068 |
| C₄= (liquid) | 0.00 | 0.00 |
| Total Gas | 68.88 | 65.28 |
| Gasoline | 30.96 | 34.60 |
| LCO | 0.00 | 0.00 |
| HCO | 0.00 | 0.00 |
| Coke | 0.164 | 0.119 |

As shown in Table 2, cracking hexane in the presence of the dual layer catalyst resulted in a slight drop in conversion due to the presence of coke on the first catalyst layer. The mol % of C₂ to C₄ olefins was 45.9 mol % for the dual layer catalyst and 47 mol % for the single layer catalyst. However, when considering the difference in conversion, the dual layer catalyst resulted in a higher selectivity of light olefins over the single layer catalyst. Thus, the dual zone reactor disclosed in the description may provide increased selectivity when used to produce light olefins.

In a first aspect of the present disclosure, light olefins may be produced from hydrocarbons by a method comprising passing a hydrocarbon feed stream into a feed inlet of a reactor. The reactor may comprise an upper reactor portion defining an upper reaction zone and a lower reactor portion defining a lower reaction zone. The upper reactor portion may comprise a catalyst inlet and a hydrocarbon product outlet where the catalyst inlet and the hydrocarbon product outlet are positioned at or near the top of the upper reactor portion. The lower reactor portion may comprise a feed inlet and a catalyst outlet, where the feed inlet and the catalyst outlet are positioned at or near the bottom of the lower reactor portion. The lower reaction zone may be in fluid communication with and adjacent to the upper reaction zone. The catalyst may move in a generally downward direction through the upper reactor portion and the lower reactor portion, and the hydrocarbon feed stream may move in a generally upward direction through the upper reactor portion and lower reactor portion such that the hydrocarbon feed stream and the catalyst move with a counter-current orientation. The upper reaction zone may operate with a counter-current plug flow regime, and the lower reaction zone may operates with a dense bed fluidization regime. Contacting the catalyst with the hydrocarbon feed stream may crack one or more components of the hydrocarbon feed stream and form a hydrocarbon product stream. The hydrocarbon product stream may comprise one or more of ethylene, propylene, or butene. The method may further comprise passing the hydrocarbon product stream out of the upper reaction zone through the hydrocarbon product outlet.

A second aspect of the present disclosure may include the first aspect where the superficial velocity of the hydrocarbon feed stream through the upper reaction zone may be 3.0 m/s or less.

A third aspect of the present disclosure may include either of the first or second aspects where the hydrocarbon feed stream comprises crude oil.

A fourth aspect of the present disclosure may include any of the first through third aspects where the hydrocarbon feed stream has an initial boiling point of at least 25° C.

A fifth aspect of the present disclosure may include any of the first through fourth aspects where the hydrocarbon feed stream comprises one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

A sixth aspect of the present disclosure may include any of the first through fifth aspects where a weight hourly space velocity of the lower reaction zone is from 1 to 200 hr⁻¹.

A seventh aspect of the present disclosure may include any of the first through sixth aspects where a catalyst to oil ratio in the upper reaction zone is from 5 to 100.

An eighth aspect of the present disclosure may include any of the first through seventh aspects where a residence time of the hydrocarbon feed stream within the reactor is from 0.1 to 10 seconds.

A ninth aspect of the present disclosure may include any of the first through eighth aspects where a temperature within the reactor is from 420° C. to 750° C.

A tenth aspect of the present disclosure may include any of the first through ninth aspects where the method further comprises passing the catalyst through the catalyst outlet to a catalyst regenerator, regenerating at least a portion of the spent catalyst to form a regenerated catalyst, and passing the regenerated catalyst to the upper reaction zone through the catalyst inlet. The catalyst passing through the catalyst outlet is spent catalyst.

An eleventh aspect of the present disclosure may include any of the first through tenth aspects where the method further comprises passing the catalyst through the catalyst outlet to a steam stripping portion of the reactor.

A twelfth aspect of the present disclosure may include any of the first through eleventh aspects where in the steam stripping portion, steam contacts the catalyst and at least a portion of hydrocarbon feed or at least a portion of hydrocarbon product are stripped from the catalyst.

In a thirteenth aspect of the present disclosure, light olefins may be produced from hydrocarbons by a method comprising passing a hydrocarbon feed stream into a feed inlet of a reactor. The reactor may comprise an upper reactor portion defining an upper reaction zone and a lower reactor portion defining a lower reaction zone. The upper reactor portion may comprise a catalyst inlet and a hydrocarbon product outlet. The catalyst inlet and the hydrocarbon product outlet may be positioned at or near the top of the upper reactor portion. The lower reactor portion may comprise a feed inlet and a catalyst outlet. The feed inlet and the catalyst outlet may be positioned at or near the bottom of the lower reactor portion. The lower reaction zone may be in fluid communication with and adjacent to the upper reaction zone. The catalyst may have a downward superficial velocity through the upper reactor portion and the lower reactor portion and the hydrocarbon feed stream may have an upward superficial velocity through the upper reactor portion and lower reactor portion such that the hydrocarbon feed stream and the catalyst move with a counter-current orientation. The upper reaction zone may operate with a counter-current plug flow regime, where the catalyst-to-oil ratio in the upper reaction zone is from 5 to 100 and the superficial velocity of the hydrocarbon feed stream in the upper reaction zone is 3.0 m/s or less. The lower reaction zone may operate with a dense bed fluidization regime, where a weight hourly space velocity of the lower reaction zone is from 1 to 200 hr-1. Contacting the catalyst with the hydrocarbon feed stream may crack one or more components of the hydrocarbon feed stream and form a hydrocarbon product stream. The hydrocarbon product stream may comprise one or more of ethylene, propylene, or butene. The method may further comprise passing the hydrocarbon product stream out of the upper reaction zone through the hydrocarbon product outlet.

A fourteenth aspect of the present disclosure may include the thirteenth aspect where the hydrocarbon feed stream comprises one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

It will be apparent to those skilled in the art that various modifications and variations can be made to the present invention without departing from the spirit and scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

1. A method for processing hydrocarbons to produce light olefins, the method comprising:
passing a hydrocarbon feed stream into a feed inlet of a reactor, wherein the reactor comprises:
an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and
a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone; and
wherein:
the catalyst moves in a generally downward direction through the upper reactor portion and the lower reactor portion and the hydrocarbon feed stream moves in a generally upward direction through the upper reactor portion and lower reactor portion such that the hydrocarbon feed stream and the catalyst move with a counter-current orientation;
the upper reaction zone operates with a counter-current plug flow regime;
the lower reaction zone operates with a dense bed fluidization regime; and
contacting the catalyst with the hydrocarbon feed stream cracks one or more components of the hydrocarbon feed stream and forms a hydrocarbon product stream, wherein the hydrocarbon product stream comprises one or more of ethylene, propylene, or butene; and
passing the hydrocarbon product stream out of the upper reaction zone through the hydrocarbon product outlet.

2. The method of claim 1, wherein the superficial velocity of the hydrocarbon feed stream through the upper reaction zone is 3.0 m/s or less.

3. The method of claim 1, wherein the hydrocarbon feed stream comprises crude oil.

4. The method of claim 1, wherein the hydrocarbon feed stream has an initial boiling point of at least 25° C.

5. The method of claim 1, wherein the hydrocarbon feed stream comprises one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

6. The method of claim 1, wherein a weight hourly space velocity of the lower reaction zone is from 1 to 200 hr⁻¹.

7. The method of claim 1, wherein a catalyst to oil ratio in the upper reaction zone is from 5 to 100.

8. The method of claim 1, wherein a residence time of the hydrocarbon feed stream within the reactor is from 0.1 to 10 seconds.

9. The method of claim 1, wherein a temperature within the reactor is from 420° C. to 750° C.

10. The method of claim 1, further comprising:
passing the catalyst through the catalyst outlet to a catalyst regenerator, wherein the catalyst passing through the catalyst outlet is spent catalyst;
regenerating at least a portion of the spent catalyst to form a regenerated catalyst; and
passing the regenerated catalyst to the upper reaction zone through the catalyst inlet.

11. The method of claim 1, further comprising passing the catalyst through the catalyst outlet to a steam stripping portion of the reactor.

12. The method of claim 11, wherein, in the steam stripping portion, steam contacts the catalyst and at least a portion of hydrocarbon feed or at least a portion of hydrocarbon product are stripped from the catalyst.

13. A method for processing hydrocarbons to produce light olefins, the method comprising:
passing a hydrocarbon feed stream into a feed inlet of a reactor, wherein the reactor comprises:
an upper reactor portion defining an upper reaction zone, the upper reactor portion comprising a catalyst inlet and a hydrocarbon product outlet, wherein the catalyst inlet and the hydrocarbon product outlet are positioned at or near the top of the upper reactor portion; and
a lower reactor portion defining a lower reaction zone, the lower reactor portion comprising a feed inlet and a catalyst outlet, wherein feed inlet and the catalyst outlet are positioned at or near the bottom of the lower reactor portion, and wherein the lower reaction zone is in fluid communication with and adjacent to the upper reaction zone; and
wherein:
the catalyst has a downward superficial velocity through the upper reactor portion and the lower reactor portion and the hydrocarbon feed stream has an upward superficial velocity through the upper reactor portion and lower reactor portion such that the hydrocarbon feed stream and the catalyst move with a counter-current orientation;
the upper reaction zone operates with a counter-current plug flow regime, wherein the catalyst-to-oil ratio in the upper reaction zone is from 5 to 100 and the superficial velocity of the hydrocarbon feed stream in the upper reaction zone is 3.0 m/s or less;
the lower reaction zone operates with a dense bed fluidization regime, wherein a weight hourly space velocity of the lower reaction zone is from 1 to 200 hr⁻¹; and
contacting the catalyst with the hydrocarbon feed stream cracks one or more components of the hydrocarbon feed stream and forms a hydrocarbon product stream, wherein the hydrocarbon product stream comprises one or more of ethylene, propylene, or butene; and
passing the hydrocarbon product stream out of the upper reaction zone through the hydrocarbon product outlet.

14. The method of claim 13, wherein the hydrocarbon feed stream comprises one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphated-dewaxed crude oil, kerosene, or diesel.

15. The method of claim 1, wherein the catalyst exhibits plug flow as it moves down through the upper reaction zone.

16. The method of claim 1, wherein the lower reactor portion has a larger cross sectional area than the upper reactor portion.

17. The method of claim 1, wherein:
the catalyst exhibits plug flow as it moves down through the upper reaction zone;
the hydrocarbon feed exhibits plug flow as it moves up through the upper reaction zone; and
the lower reactor portion has a larger cross sectional area than the upper reactor portion.
